(19) United States
(12) Patent Application Publication
(10) Pub. No.: US 2015/0278217 A1
(43) Pub. Date: Oct. 1, 2015

(54) METHOD AND APPARATUS FOR SHARED LISTENING OF MEDIA FILES

(71) Applicant: ETHR, LLC, Venice, CA (US)

(72) Inventor: Alex Patrick SCHAFFHAUSEN, Venice, CA (US)

(21) Appl. No.: 14/593,976

(22) Filed: Jan. 9, 2015

Related U.S. Application Data
(60) Provisional application No. 61/973,698, filed on Apr. 1, 2014.

(51) Int. Cl. G06F 17/30; G06F 3/0482; G06F 3/0484; H04L 29/06

(52) U.S. Cl. CPC G06F 17/30053; H04L 65/601; G06F 3/0482; G06F 3/04842

(57) ABSTRACT

A system for allowing multiple users to receive the same media stream. An exemplary such system comprises one or more hardware processors collectively programmed to maintain and update a list of playlists, each playlist representing a first media transmission currently being transmitted for a user, the users for the playlists collectively forming a first set of users. The system is further programmed to receive selections of playlists, the selections representing ones of the playlists selected by a second set of users different from the first set of users, the selections collectively forming a selected set of the playlists. The system is further programmed to, for each playlist of the selected set of the playlists, initiate the direction of a second media transmission to the corresponding second user, the second media transmission being substantially identical to and synchronous with the corresponding first media transmission for the corresponding first user.

This application claims priority to, and the benefit of, U.S. Provisional Patent Application No. 61/973,698 filed on Apr. 1, 2014, the entire content of which is incorporated by reference herein.

### BRIEF DESCRIPTION

Embodiments of the invention relate generally to the use of computer systems and applications as file transfer and transmission tools. More specifically, embodiments of the invention relate to methods and apparatuses for shared listening of media files.

### BACKGROUND

While services exist for listening to audio files, such as music, online, and broadcasting of audio has existed for some time, neither of these services allows for any one individual to see and hear, in real time, what another individual is listening to. More specifically, the many services for listening to audio files typically stream or otherwise transmit audio files to a specific listener, without informing other listeners of those specific audio files. It is left to the listener to inform others of what they are listening to, perhaps through separate social media services or other vehicles for conveying such information. Conversely, audio broadcast, such as by conventional radio, broadcasts audio to a wide range of listeners, essentially anyone who is within range and has a suitable receiver. While many receive the same audio signal, one typically does not know what another is listening to unless one is within earshot, which is not always the case.

### SUMMARY OF THE INVENTION

The invention can be implemented in numerous ways. Accordingly, various embodiments of the invention are discussed below.

In one embodiment, a system comprises one or more hardware processors collectively programmed to: maintain and update a list of playlists, each playlist representing a first media transmission currently being transmitted for a user, the users for the playlists collectively foiming a first set of users; receive selections of playlists, the selections representing ones of the playlists selected by a second set of users different from the first set of users, the selections collectively forming a selected set of the playlists; and for each playlist of the selected set of the playlists, initiate the direction of a second media transmission to the corresponding second user, the second media transmission being substantially identical to and synchronous with the corresponding first media transmission for the corresponding first user.

The one or more hardware processors may be further programmed to receive the selections of playlists from mobile computing devices.

The one or more hardware processors may be further programmed to receive media selections identifying particular media, to generate further playlists from the media selections, and to update the list of playlists by adding the further playlists to the list of playlists.

The one or more hardware processors may be further programmed to receive an indicator of approval of at least a portion of the first media transmission, and to transmit the approval to one or more of the users.

The one or more hardware processors may be further programmed to select additional media content corresponding to the selected set of the playlists, and to transmit the selected additional media content to the corresponding second users.

The additional media content may include any one or more of: related media, advertisements, identities of other users, artists, related events, and currently popular media.

The one or more hardware processors may be further programmed to maintain a profile of one or more users of the second set of users, the profile including any one or more of: identifiers of media previously selected, media previously preferred, categories of media previously selected, durations that media were received for, dates and/or times at which media was received, identities of other users that media were shared with, identifiers of users whose playlists were selected, and identifiers of followed users.

The one or more hardware processors may be further programmed to select suggested media for the one or more users of the second set of users, the selected suggested media based on the profile of the one or more users of the second set of users.

The may be any one or more of digital audio files, and digital video files.

In another embodiment, a method of allowing multiple users to receive the same media stream may comprise: transmitting to a first computer a list of playlists, the playlists corresponding to media currently being streamed to respective other computers different from the first computer; receiving from the first computer a selection of one of the playlists, so as to identify a selected one of the playlists; and initiating a streaming, to the first computer, of the media corresponding to the selected one of the playlists, so that the first computer and the other computer corresponding to the selected one of the playlists each are streamed substantially the same media in substantially synchronous manner.

The method may further comprise receiving media selections identifying particular media; generating further playlists from the media selections; and updating the list of playlists by adding the further playlists to the list of playlists.

The method may further comprise receiving an indicator of approval of at least a portion of the selected one of the playlists; and transmitting the approval to one or more computational devices.

The method may further comprise selecting additional media content corresponding to the selected one of the playlists; and transmitting the selected additional media content to one or more computational devices.

The method may further comprise maintaining a profile of one or more users of the first computer, the profile including any one or more of: identifiers of media previously selected, media previously preferred, categories of media previously selected, durations that media were received for, dates and/or times at which media was received, identities of other users that media were shared with, identifiers of users whose playlists were selected, and identifiers of followed users.

The method may further comprise selecting suggested media for the one or more users of the first computer, the selected suggested media based on the profile of the one or more users of the first computer.

In a further embodiment, a set of one or more non-transitory computer-readable media may be implemented for storing computer-readable instructions for carrying out a method of allowing multiple users to receive the same media stream. The method comprises: transmitting to a first computer a list of playlists, the playlists corresponding to media currently being streamed to respective other computers different from the first computer; receiving from the first computer a selection of one of the playlists, so as to identify a selected one of the playlists; and initiating a streaming, to the first computer, of the media corresponding to the selected one of the playlists, so that the first computer and the other computer corresponding to the selected one of the playlists each are streamed substantially the same media in substantially synchronous manner.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For better understanding of the disclosure, reference is made in the following detailed description to the accompanying drawings, in which:

FIG. 1 illustrates an exemplary computer-based system for implementing embodiments of the present invention;

FIG. 2 is a flowchart illustrating steps taken by users in account creation;

FIG. 3 is a flowchart illustrating steps taken by users in playlist selection;

FIG. 4 is a flowchart illustrating steps taken by users in playlist creation;

FIG. 5 is a flowchart illustrating steps taken by users in searching for audio content; and

FIG. 6 illustrates a further exemplary computer-based system for implementing embodiments of the present invention.

Like reference numerals refer to corresponding parts throughout the drawings. The various Figures are not to scale.

### DETAILED DESCRIPTION

Embodiments of the present invention allow for the live, real time sharing of media such as audio files. Users can see what another user is currently listening to, can listen along, and can inform other users of what they or that other user are listening to. To allow this, users can create playlists of media such as audio files, and play one of their playlists. Other users can see this playlist, as well as listen to the file currently being played. In this manner, each user can compile a playlist of audio such as music, playing this music for themselves, as well as allowing other users to listen or watch along in real time, creating a platform for shared listening. Users listening to another's playlist effectively receive a radio feed of sorts, allowing them to listen in on someone's playlist as it is being played. This information can then be shared with still further users, along with comments and the like.

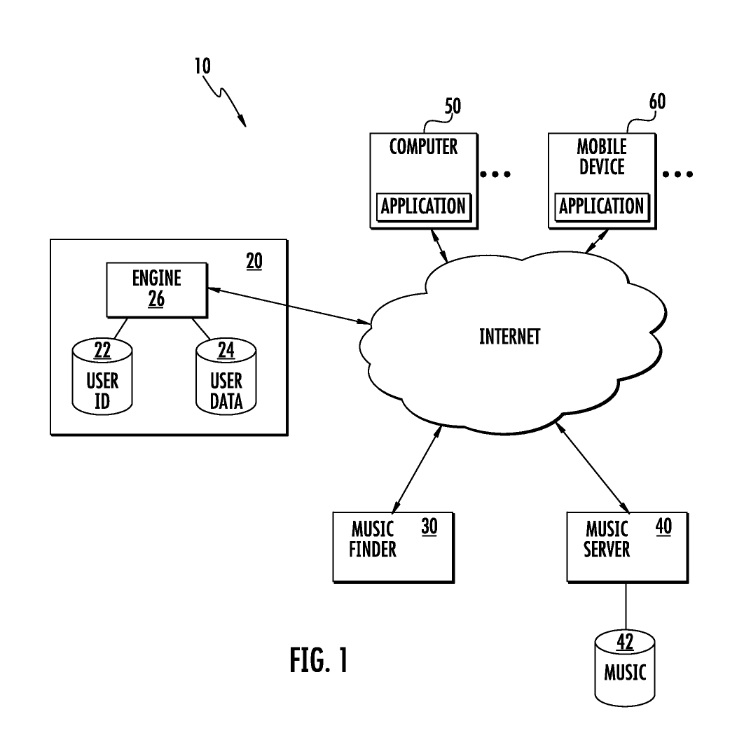

FIG. 1 illustrates an exemplary computer-based system for implementing embodiments of the present invention. In FIG. 1, system 10 includes a server 20 connected to the Internet or other computer-based communications network, along with any number of computers 50 and mobile computing devices 60. The computers 50 can be desktop computers or any other computational devices capable of communication with server 20, and the mobile devices 60 can be any mobile computational devices such as smartphones, tablet computers, laptops, or the like. Each of the computers 50 and mobile devices 60 can run one or more application programs for interfacing and communicating with both server 20 and users. The system 10 also includes a music finder server 30 and music server 40. The music finder server 30 identifies music or other audio files that satisfy specified criteria, and the music server 40 serves as a storehouse of audio files by maintaining a music database 42. As used herein, “music” can refer broadly to any computer file storing audio information. Music server 40 can be any computer storing a catalog of audio files. For example, music server 40 can be a Medianet™ server, a 7Digital™ server, a digital service provider (DSP) server, or any other computer or service storing audio files. It should be noted that the audio files employed by embodiments of the invention need not necessarily be resident on a remote server 40, and can be located anywhere, such as on a database within server 20 or on one or more networked computers.

Server 20 includes one or more databases including a user ID database 22 and user data 24, as well as an engine 26. The user ID database 22 stores user identification/login information such as usernames and passwords, as well as associated identification information such as the name, physical address, and other information for the people associated with the usernames. User data 24 is a storehouse of recorded information corresponding to users' actions when using system 10. For example, user data 24 can store historical data on user preferences, such as the songs users have elected to listen to over time, in order to help determine future suggestions for that user. Other information that may be stored includes user social profile information, or any other information on a user. Embodiments of the invention contemplate any such information, without limitation. Engine 26 is software that includes any database management and interface programs, as well as software for implementing the various methods and processes described herein.

In operation, users can login to the system 10 using the application on their computer 50 or mobile device 60, and create a user profile (including login information such as username and password) that is stored in user ID database 22. The user can then view and select other users, to hear their live audio feeds. Audio files are retrieved from music server 40 and streamed through engine 26, so that when users select another user's live feed, the engine 26 streams that feed to that additional user as well. In this manner, users can select and receive a stream that is identical to and synchronous with the selected stream. That is, users can hear what another user is listening to, in real time, while that other user is listening to it. Users can also make their own playlists of audio files and play them, whereupon other users can select their feed for listening along. Playlists can be user generated, either by users selecting audio files by themselves, or with the help of music finder 30.

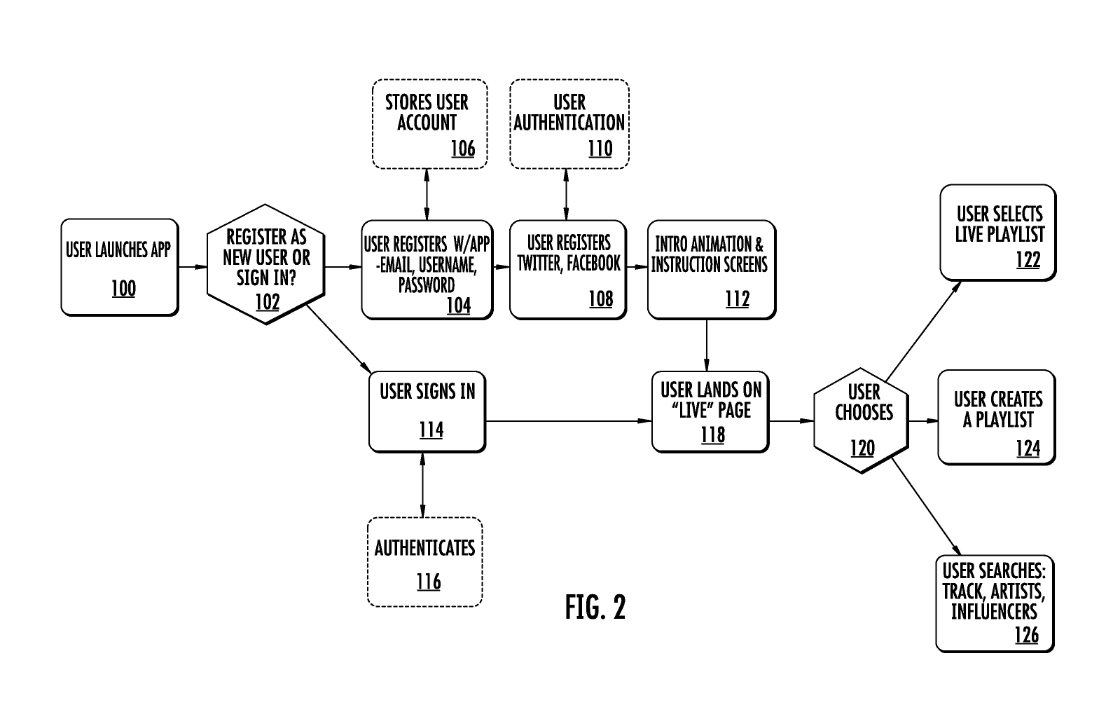

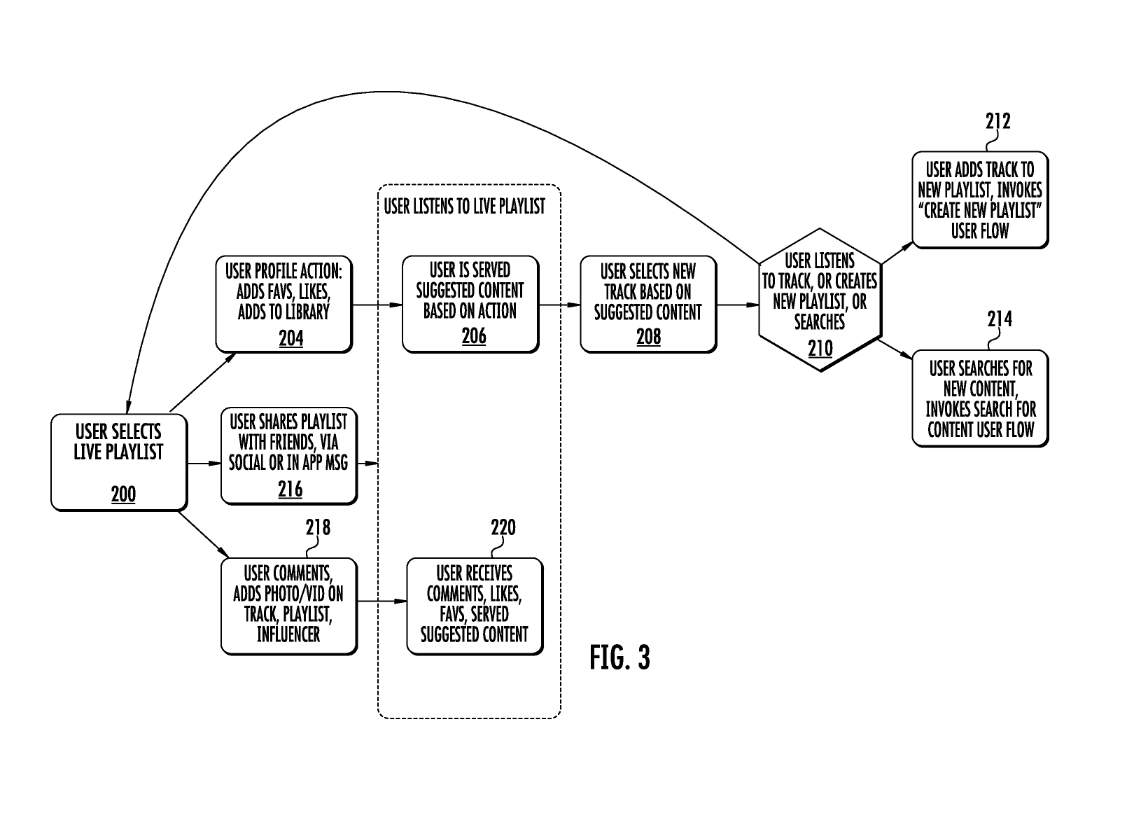

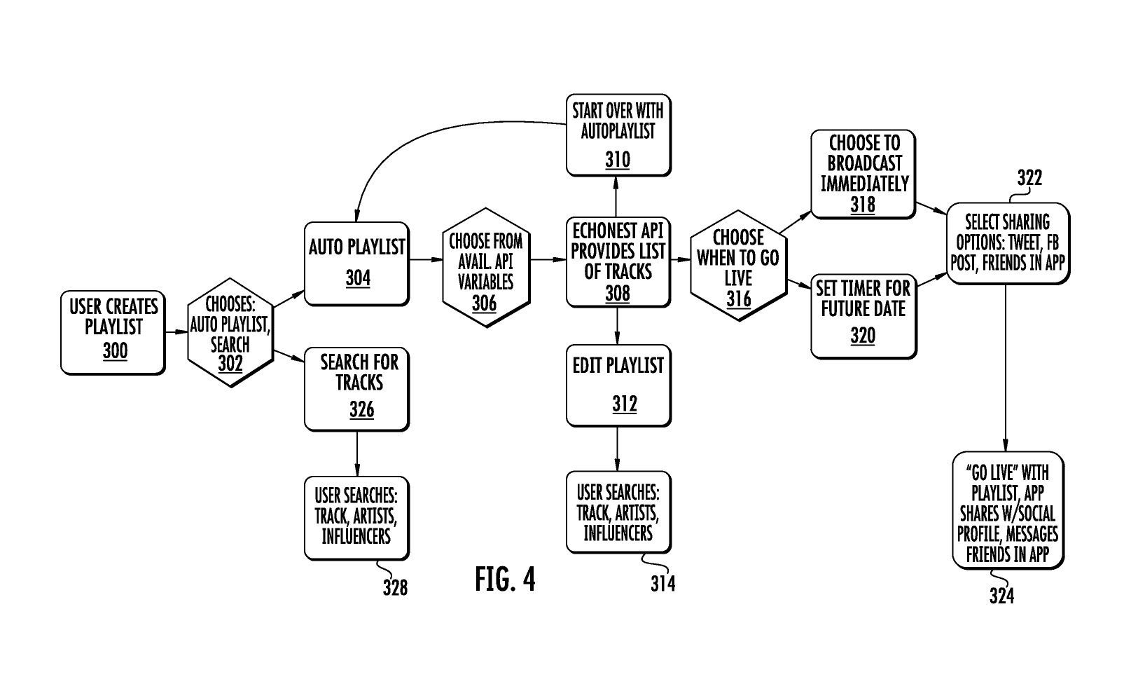

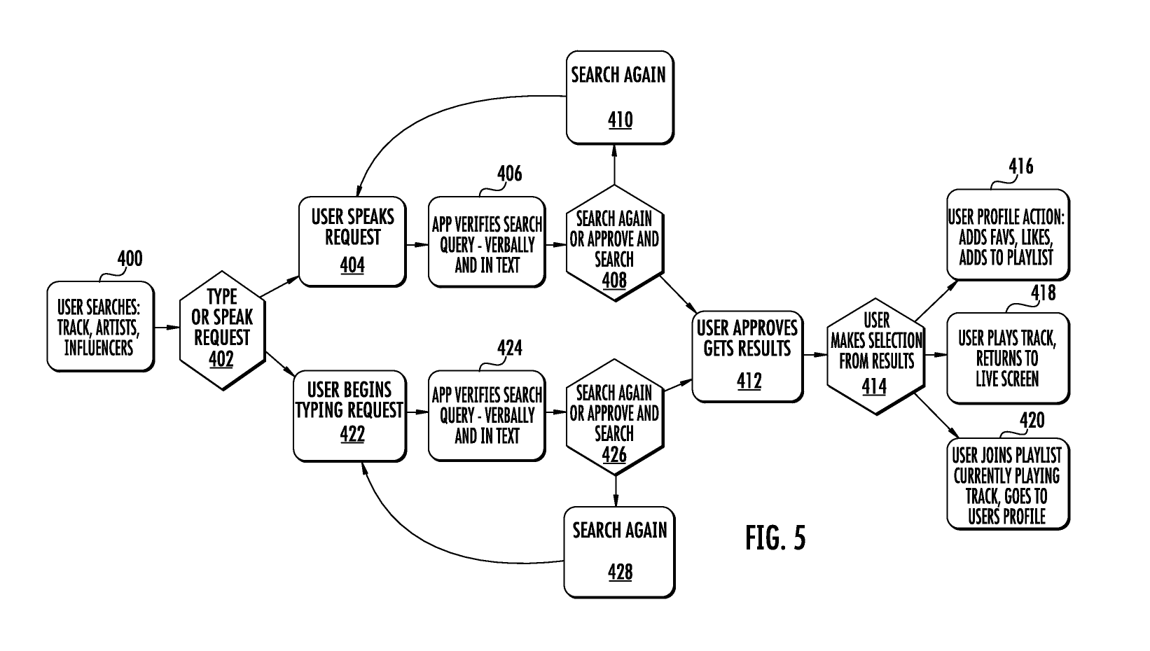

As described above, system 10 perforins a number of functions, including user account creation, playlist selection and creation, and searching for and selecting audio content. FIG. 2 illustrates further details of the account creation process. The process begins with a user launching the application program on their computer 50 or mobile device 60 (Step 100). The application has a login screen permitting the user to either register as a new user, or sign in if the user has an existing account (Step 102). If the user is a new user, he or she must register as such. The application thus prompts the user to enter identification information sufficient to establish a user account, such as a username and password, as well as an email address (Step 104). Any information is contemplated. For example, instead of (or in addition to) an email address, users may be prompted or allowed to enter a physical address, phone number(s), etc. It should be noted that the account may not be for a specific person, but may instead be for an event or activity.

Any such information entered is stored in the user ID database 22, associated with that user's account (Step 106). The application program may also prompt the user to enter or register other information such as social media IDs (Step 108). For example, the user may be prompted to enter their Twitter™ or Facebook™ handles/usernames or login information. Any such social media or identifiers for other interpersonal communication programs are contemplated. Once entered, this information is also stored in the user ID database 22, and the engine 26 authenticates the user to verify the accuracy of the handles/usernames (Step 110).

The application then displays any introductory animation and/or instruction screens welcoming the new user and instructing him or her on how to begin (Step 112). These screens may allow for entry of further information. For example, if the account is for an event or activity, screens may allow for entry of information describing the event/activity, its location and time, etc. After clearing these screens, the application displays users the “live” page, allowing them to select other users (Step 118). Alternatively, existing users can also arrive at this live page after simply signing in (Step 114), whereupon the engine 26 retrieves their information from user ID database 22 and authenticates them (Step 116).

Once on the live page, the user is allowed to perform at least three different actions, perhaps by prompts (Step 120). First, the user (user 1) can select another user's (user 2's) live playlist (Step 122), whereupon engine 26 will stream user 2's playlist from music server 40 to both user 2 and user 1 simultaneously. User 1 may also be shown information related to user 2's playlist, such as album cover art for the song or audio file currently playing, song information (title, length, album name, etc.), or the like. Second, the user can create and play their own playlist (Step 124). This can be done in a number of ways. For example, users can simply search for and select songs on their own, with the application and engine 26 providing a search function for the user. Alternatively, the application program can prompt the user to enter specific criteria or variables indicating his or her music preferences (or preferences for any other form of audio), and the application can send these variables/selections to music finder 30. The music finder 30 can be any server, computer, or other program containing analytics for identifying audio files that may satisfy a user's selected criteria or variables. As one example, the music finder 30 may be an Echo Nest™ server providing music intelligence services that return songs or other audio that it determines satisfies the variables transmitted to it by the application. The desired music intelligence can be implemented as an application programming interface (API), specifying how variables are input and how results are returned. Users can then select from among the audio files returned by the music finder 30, to form their playlist. users can select and play individual songs or audio files, such as by searching (Step 126). This searching can be by any criteria, e.g. by track within an album, artist or song name, influencer, or the like.

One of ordinary skill in the art will realize that the above described audio selection analytics can be implemented on a separate music finder 30 server, or as part of engine 26. The invention contemplates the implementation of any such analytics, selecting audio files according to any method and/or criteria, in any suitable program in any server, whether it is remote to server 20 or otherwise.

Attention now turns to a more detailed description of Steps 122, 124, and 126.

### Selection of Live Playlists

As noted above, Step 122 involves a user, such as user 1, selecting the playlist of another user, user 2. User 2's playlist is then streamed live to user 1 through engine 26, so that user 2's playlist is being streamed simultaneously to both user 1 and user 2. In more detail, a user such as user 1 first selects a live playlist from a compilation of playlists presented to them by their application (Step 200). These playlists can be compiled and presented to user 1 in any manner. For example, the engine 26 or application may choose to retrieve and present the playlists of the user's social media friends (i.e. those designated as friends by user 1's associated social media accounts, the information for which was entered at Step 108), celebrities or other notable individuals or organizations, or any other playlists of individuals deemed relevant. The invention contemplates the selection and presentation of playlists in any manner.

Once user 1 has selected a playlist, the user is given the option to take at least three further actions. First, the user can indicate his or her preference for the selected playlist in some manner (Step 204). For example, the user can designate the selected playlist as a favorite, or “like” the playlist (or send some other indicator of approval), and add one or more audio files of the playlist to a library of favorites for future playback. This preference information is stored in user data storage 24, and can be later used as a variable transmitted to music finder 30, to help determine other audio files that the user may be interested in.

Also, upon playlist selection, the selected playlist is streamed live to user 1 through engine 26 and his/her application program. This effectively provides user 1 with an individual, real time broadcast of the audio feed that user 2 is listening to. In addition, at any suitable time, user 1's application can also present him or her with other suggested content (Step 206). This content can be determined based on the actions of user 1 (as stored, for example as a list of audio files or any other information listened to or selected in the past, in user data 24), and can include other music or audio files, other users such as athletes, influencers, or celebrities who may be of interest, artists, events, or highlights of “what's trending” or what may be currently popular, either with the users of system 10 or in the general news. The user can then select new tracks, or audio files, based on this suggested content (Step 208), whereupon this new selected track is streamed to the user. At this point, the user is given the option of creating a new playlist with the new selected content, or searching for another user's playlist or some other audio file (Step 210). If the user selects another's playlist, the process returns to Step 200. Alternatively, if the user elects to create a new playlist (Step 212) or to search for another audio file (Step 214), the process turns to the appropriate Step further described below.

### Playlist Creation

Step 124 involves user creation of a playlist. This playlist can be played by the user creating the playlist, and can also be selected by other users, allowing them to hear what the playlist's user is listening to, in real time. The user can first select playlist creation from their application (Step 300). The user is then prompted to select either auto playlist compilation, or manual searching for audio files to add to the playlist (Step 302).

If auto playlist compilation is selected (Step 304), the user is then offered a number of variables to choose values of (Step 306). These variables are any variables which may be used to determine audio files that the user may be interested in listening to. For example, variables may be those which help determine which genre of music, and which songs within that genre, the user may wish to listen to. Examples of such variables include, but are not limited to, The popularity and genres of music selections, recent activity, new releases/artists/tracks/playlists listened to or selected, listening duration, loudness of songs or volume at which they are listened to, song type (live, holiday, studio, acoustic, etc.), user location, user mood, selected track information such as danceability, “hotness”, mood, etc. Any other variables are contemplated. The set of variables may correspond to those which the API of music finder 30 is programmed to use.

Once the user selects and enters values for these variables, the values are transmitted to the API of the music finder 30 by the application or the engine 26. The music finder 30 then employs its analytics to determine a corresponding list of audio files that may be of interest to the user, and returns this list (Step 308). The invention includes any such analytics, and the selection of suggested audio files for a user according to any methods. For example, files of potential interest to users may be determined according to a user taste profile stored for each user. This file may store any and all past user actions, including songs or other audio files listened to, commented on, added to a list of likes or other preferred audio, and the genre or type that each such audio file belongs to. Other information stored may include how long each track was listened to, date/time it was listened to, people whom these audio files were shared with, playlists listened to, other users followed, etc. Any user actions may be included. This user taste profile may then be used to make suggestions, in any manner. For example, popular titles within genres that the user has selected many audio files may be suggested, or other songs by an artist who the user may have listened to often may also be suggested. Statistical analyses may also be performed to determine that listeners to particular artists/songs/playlists/celebrities also tend to listen to other particular artists/songs/playlists/celebrities, or the like, with suggestions made accordingly. Any such methods of forming suggestions are contemplated.

The music finder 30 may return both identifiers describing the suggested audio files, as well as their uniform resource locators (URLs), to the engine 26 so that, when the user selects a particular audio file, the engine 26 knows its location. In this example, the URL can point to a particular audio file stored by music server 40, although any location is contemplated.

It should be noted that the functionality of the music finder 30 can be located anywhere, including at a remote server such as server 30, or locally on server 20. For example, the analytics may be implemented as code within engine 26 or some other program run by server 20.

If the user does not like any of the returned suggestions (Step 310), the process can return to Step 304, and the user can select different variables, and different values thereof, to receive a different set of suggestions. Alternatively, if the user likes one or more of the returned tracks, the user may select the tracks for addition to their playlist (Step 312), whereupon the application and/or engine 26 may return information on these selected tracks to the music finder 30 in the form of variable values, to refine the search and add more relevant suggested tracks (Step 314). The variables may be track titles, artists, influencers, or any other variables that the API is programmed to accept.

The application gives the user the ability to choose when to “go live” with their playlist (Step 316), i.e. to choose the point in time when other users are allowed to view the playlist. Once the user elects to go live with their playlist, the application allows the user to go live immediately (Step 318), or to set a timer for the playlist to go live at a predetermined future time (Step 320). The timer may be useful when, for example, the user account is for a specific event, so that the playlist is an event-specific playlist which is desired to go live at the start of the event. The user can then be prompted to share this playlist with others upon going live, by selecting social media accounts for broadcasting of the newly-completed playlist (Step 322). Sharing can be performed in any manner. As one example, the engine 26 can direct the user's social media accounts (for which it has the appropriate user information stored in user ID database 22), including other users of system 10, to broadcast notifications of the playlist. The invention contemplates the broadcasting of such information through any social media or other communication service, in any manner, including transmission to other users of system 10 (i.e. other applications of computers 50 and mobile computing devices 60). Once the playlist goes live, the engine 26 then automatically broadcasts notifications via all selected social media accounts (Step 324).

If at Step 302 the user selects searching for tracks (Step 326) instead of auto-generating a playlist, the application and engine 26 allow the user to search for audio content by entering search terms (Step 328), and selecting audio files from among the returned search results. Searching may also be performed on playlists rather than solely on audio files. More specifically, previously-created playlists can be stored in user data 24 or elsewhere, and searching can be on any objects or fields within that database, including old playlists of the searching user or any other users. Tracks from returned playlists, or the entire playlists themselves, may be selected and played. Search functionality can be implemented in any manner, and is further described below.

Content Searches

Step 126, as well as Steps 326-328, involve user searches for content. Here, the user can select the option to conduct his or her own search for audio content (Step 400). Once the search option is selected, the application gives the user the further option of entering search terms either by typing or speaking (Step 402), although the invention contemplates any type of searching, by any method. Searching can be by any criteria, including track title, artist name, album name, influencer, etc. If the user selects the speaking option, he or she can speak their search request (Step 404), with the application verifying the search query once the user has finished speaking (Step 406), and giving the user the option of either approving the search, or attempting another request (Step 408). If the application has not properly translated the spoken search query, or if the user has decided to conduct a different search for some reason, the user can opt to discard the previous search query and enter a new one (Step 410), at which point the process returns to Step 404. Conversely, if the application has correctly translated the spoken search query, the user can approve the query, whereupon the search is conducted and the application presents the search results to the user (Step 412). Searching can be performed in any manner, such as by searching the file names and associated metadata of the audio files stored in music server 40. Searching can also be performed on users, events, activities, or anything stored in any of the databases or storages of system 10. In this manner, the user can search for such things as audio files, as well as other users, specific events or activities, playlists of the searching user or others, etc.

The user then can select audio files from among the returned search results, if desired (Step 414). The user then is presented the option to add the selected files to their playlist, along with adding the selected file to a list of favorites or likes (Step 416), similar to Step 204. The user is also presented with the option to simply play the selected audio files and return to Step 118 (Step 418), or to instead join another playlist (Step 420). If the user elects to play the audio file, the engine 26 locates the audio file via the URL returned by music finder 30, and streams the audio file from music server 40 to the user's computational device. If the user instead elects to join another playlist, the process returns to Step 122.

If, at Step 402, the user instead elects to enter a typewritten search request, the user is allowed to type his or her request (Step 422), whereupon the application presents the completed request to the user for verification, textually and/or verbally (Step 424), and the user is given the option to either accept the search query or enter a new one (Step 426). If the user elects to enter a new query (Step 428), the process returns to Step 422, and if the user approves of the current query, the process instead goes to Step 412 and proceeds as above.

Embodiments of the invention allow for the real time sharing of audio playlists, with users selecting and listening to the playlists of others as they are being played. In this manner, users can see and listen to exactly what others are listening to, as they are listening to it, akin to logging on to a personal radio broadcast. Also, users playing audio can effectively broadcast their live music feed to anyone else who wishes to listen in.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). One example may be the analytics implemented by music finder 30. Such components, inter alfa, can automate certain mechanisms or processes performed thereby to make portions of the systems and methods more adaptive as well as efficient and intelligent.

In view of the exemplary systems described above, methodologies that may be implemented in accordance with the disclosed subject matter will be better appreciated with reference to the flow charts provided. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

As used herein, the terms “component,” “system” and the like are intended to refer to a computer-related entity, either hardware, a combination of hardware and software, software, or software in execution. For example, a component can be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

Furthermore, all or portions of the subject disclosure may be implemented as a method, apparatus or article of manufacture using standard programming and/or engineering techniques to produce software, firmware, hardware, or any combination thereof to control a computer to implement the disclosed concepts. The term “article of manufacture” as used herein is intended to encompass a computer program accessible from any non-transitory computer-readable device or media. For example, a non-transitory computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

In order to provide a context for the various aspects of the disclosed subject matter, FIG. 6 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 6, an exemplary environment 600 for implementing various aspects disclosed herein includes a host system 610 (a computer, e.g., desktop, laptop, server, hand held gadgets including but not limited to smartphone, programmable consumer or industrial electronics . . . ). The host system 610 can be an example of server 20, for instance. Host system 610 includes a processing unit 612, a system memory 614 and a system bus 620. The system bus 620 couples system components including, but not limited to, the system memory 614 to the processing unit 612. The processing unit 612 can be any of various available microprocessors. It is to be appreciated that dual microprocessors, multi-core and other multiprocessor architectures can be employed as the processing unit 612.

The system memory 614 includes volatile and nonvolatile memory. The basic input/output system (BIOS), containing the basic routines to transfer information between elements within the host system 610, such as during start-up, is stored in nonvolatile memory. By way of illustration, and not limitation, nonvolatile memory can include read only memory (ROM). Volatile memory includes random access memory (RAM), which can act as external cache memory to facilitate processing.

The host system 610 may also include removable/non-removable, volatile/non-volatile computer storage media. FIG. 6 illustrates, for example, mass storage 616. Mass storage 616 includes, but is not limited to, devices like a magnetic or optical disk drive, floppy disk drive, flash memory, or memory stick. In addition, mass storage 616 can include storage media separately or in combination with other storage media. An SSD device may be implemented as the mass storage 916. The SSD device is not limited to being connected to or communicating with the host system in any specific manner.

FIG. 6 provides software Program(s) that act as an intermediary between users and/or other computers and the basic computer resources described in suitable operating environment 600. Such Program(s) include one or both of system and application software. Application software includes one or more Applications. System software can include an operating system 622, which can be stored on mass storage 616, that acts to control and allocate resources of the computer system 610. Application software takes advantage of the management of resources by system software through program modules and data stored on either or both of system memory 614 and mass storage 616. The engine 26 can be an example of one or more of the Program(s), for instance.

The host system 610 also includes one or more interface components 618 that are communicatively coupled to the bus 620 and facilitate interaction with the computer 610. By way of example, the interface component 618 can be a port (e.g., serial, parallel, PCMCIA, USB, FireWire . . . ) or an interface card (e.g., sound, video, network . . . ) or the like. The interface component 618 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 610 to output device(s) via interface component 618. Output devices can include displays (e.g., CRT, LCD, plasma . . . ), speakers, printers and other computers, among other things.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, embodiments of the invention contemplate the compiling of playlists in any manner, including any form of searching or selecting of any form of audio file. The embodiments were chosen and described in order to best explain the principles of the invention and its practical applications, to thereby enable others skilled in the art to best utilize the invention and various embodiments with various modifications as are suited to the particular use contemplated. The various features of the disclosed embodiments and examples may be mixed and matched in any manner or combination to form further embodiments contemplated by the invention.

What is claimed is:

1. A system, comprising:
one or more hardware processors collectively programmed to:
maintain and update a list of playlists, each playlist representing a first media transmission currently being transmitted for a user, the users for the playlists collectively forming a first set of users;
receive selections of playlists, the selections representing ones of the playlists selected by a second set of users different from the first set of users, the selections collectively forming a selected set of the playlists; and
for each playlist of the selected set of the playlists, initiate the direction of a second media transmission to the corresponding second user, the second media transmission being substantially identical to and synchronous with the corresponding first media transmission for the corresponding first user.

2. The system of claim 1, wherein the one or more hardware processors are further programmed to receive the selections of playlists from mobile computing devices.

3. The system of claim 1, wherein the one or more hardware processors are further programmed to receive media selections identifying particular media, to generate further playlists from the media selections, and to update the list of playlists by adding the further playlists to the list of playlists.

4. The system of claim 1, wherein the one or more hardware processors are further programmed to receive an indicator of approval of at least a portion of the first media transmission, and to transmit the approval to one or more of the users.

5. The system of claim 1, wherein the one or more hardware processors are further programmed to select additional media content corresponding to the selected set of the playlists, and to transmit the selected additional media content to the corresponding second users.

6. The system of claim 5, wherein the additional media content includes any one or more of: related media, advertisements, identities of other users, artists, related events, and currently popular media.

7. The system of claim 1, wherein the one or more hardware processors are further programmed to maintain a profile of one or more users of the second set of users, the profile including any one or more of: identifiers of media previously selected, media previously preferred, categories of media previously selected, durations that media were received for, dates and/or times at which media was received, identities of other users that media were shared with, identifiers of users whose playlists were selected, and identifiers of followed users.

8. The system of claim 7, wherein the one or more hardware processors are further programmed to select suggested media for the one or more users of the second set of users, the selected suggested media based on the profile of the one or more users of the second set of users.

9. The system of claim 1, wherein the media is any one or more of digital audio files, and digital video files.

10. A method of allowing multiple users to receive the same media stream, the method comprising:
transmitting to a first computer a list of playlists, the playlists corresponding to media currently being streamed to respective other computers different from the first computer;
receiving from the first computer a selection of one of the playlists, so as to identify a selected one of the playlists; and
initiating a streaming, to the first computer, of the media corresponding to the selected one of the playlists, so that the first computer and the other computer corresponding to the selected one of the playlists each are streamed substantially the same media in substantially synchronous manner.

11. The method of claim 10, further comprising:
receiving media selections identifying particular media;
generating further playlists from the media selections; and
updating the list of playlists by adding the further playlists to the list of playlists.

12. The method of claim 10, further comprising:
receiving an indicator of approval of at least a portion of the selected one of the playlists; and
transmitting the approval to one or more computational devices.

13. The method of claim 10, further comprising:
selecting additional media content corresponding to the selected one of the playlists; and
transmitting the selected additional media content to one or more computational devices.

14. The method of claim 13, wherein the additional media content includes any one or more of: related media, advertisements, identities of other users, artists, related events, and currently popular media.

15. The method of claim 10, further comprising maintaining a profile of one or more users of the first computer, the profile including any one or more of: identifiers of media previously selected, media previously preferred, categories of media previously selected, durations that media were received for, dates and/or times at which media was received, identities of other users that media were shared with, identifiers of users whose playlists were selected, and identifiers of followed users.

16. The method of claim 15, further comprising selecting suggested media for the one or more users of the first computer, the selected suggested media based on the profile of the one or more users of the first computer.

17. The method of claim 10, wherein the media is any one or more of digital audio files, and digital video files.

18. A set of one or more non-transitory computer-readable media storing computer-readable instructions for carrying out a method of allowing multiple users to receive the same media stream, the method comprising:
transmitting to a first computer a list of playlists, the playlists corresponding to media currently being streamed to respective other computers different from the first computer;
receiving from the first computer a selection of one of the playlists, so as to identify a selected one of the playlists ; and
initiating a streaming, to the first computer, of the media corresponding to the selected one of the playlists, so that the first computer and the other computer corresponding to the selected one of the playlists each are streamed substantially the same media in substantially synchronous manner.

19. The non-transitory computer-readable media of claim 18, wherein the method further comprises:
receiving media selections identifying particular media;
generating further playlists from the media selections; and
updating the list of playlists by adding the further playlists to the list of playlists.

20. The non-transitory computer-readable media of claim 18, wherein the method further comprises:
receiving an indicator of approval of at least a portion of the selected one of the playlists; and
transmitting the approval to one or more computational devices.

21. The non-transitory computer-readable media of claim 18, wherein the method further comprises:
selecting additional media content corresponding to the selected one of the playlists; and
transmitting the selected additional media content to one or more computational devices.

22. The non-transitory computer-readable media of claim 21, wherein the additional media content includes any one or more of: related media, advertisements, identities of other users, artists, related events, and currently popular media.

23. The non-transitory computer-readable media of claim 18, wherein the method further comprises maintaining a profile of one or more users of the first computer, the profile including any one or more of: identifiers of media previously selected, media previously preferred, categories of media previously selected, durations that media were received for, dates and/or times at which media was received, identities of other users that media were shared with, identifiers of users whose playlists were selected, and identifiers of followed users.

24. The non-transitory computer-readable media of claim 23, wherein the method further comprises selecting suggested media for the one or more users of the first computer, the selected suggested media based on the profile of the one or more users of the first computer.

25. The non-transitory computer-readable media of claim 18, wherein the media is any one or more of digital audio files, and digital video files.
